(19) United States
(12) Patent Application Publication
(10) Pub. No.: US 2012/0062819 A1
(43) Pub. Date: Mar. 15, 2012

(54) LED CIRCUIT WITH ZENER DIODES

(75) Inventors: William Dunn, Alpharetta, GA (US); David Williams, Canton, GA (US)

(73) Assignee: MANUFACTURING RESOURCES INTERNATIONAL, INC., Alpharetta, GA (US)

(21) Appl. No.: 13/024,834

(22) Filed: Feb. 10, 2011

Related U.S. Application Data
(60) Provisional application No. 61/303,150, filed on Feb. 10, 2010.

(51) Int. Cl. G02F 1/1335; H05B 37/02

(52) U.S. Cl. 349/64; 315/122

(57) ABSTRACT

A light emitting diode (LED) circuit having a plurality of LEDs electrically connected in series with a zener diode electrically connected to each LED in parallel. If an LED were to fail, the current can be routed around the failed LED, through the zener diode, and continue through the rest of the LEDs in the series connection. Thus, a failure in one LED does not cause the entire series string to lose their illumination. Some embodiments may place several LED strings in parallel with one another. Exemplary embodiments may mount the LCDs on a metal core printed circuit board (PCB). Further embodiments may place a thin metallic sheet or metallic surface on the rear surface of the PCB and in thermal communication with the PCB and/or LEDs.

### CROSS-REFERENCE TO RELATED APPLICATIONS

This application claims priority to U.S. application Ser. No. 61/303,150 filed on Feb. 10, 2010, the entirety of this application is herein incorporated by reference.

### TECHNICAL FIELD

Exemplary embodiments relate generally to a circuit configuration for LEDs where the circuit contains Zener diodes which maintain current flow after the failure of one or more LEDs in the circuit.

### BACKGROUND OF THE ART

In various lighting applications, a number of concerns have prompted the lighting industry to begin utilizing light emitting diodes (LEDs) for providing the illumination source. LEDs are now used for many applications including but not limited to: architectural lighting, backlighting for static displays, backlighting for liquid crystal displays (LCDs), flashlights and other lamps, and home/office interior lighting. Often, LEDs may be electrically connected as a number of strings connected in series. However, when an LED in the circuit fails, the flow of current may be disrupted and the illumination of the assembly may be affected. In some cases, current will no longer pass through some of the LEDs and there may be noticeable dark spots in the assembly from their lack of illumination. Alternatively, the desired current levels will be disrupted and the illumination from surrounding LEDs will be affected.

### SUMMARY OF THE EXEMPLARY EMBODIMENTS

Exemplary embodiments may connect a Zener diode in parallel with each LED so that if the LED were to fail, the current may flow through the Zener diode and the circuit and surrounding LEDs may continue to provide the desired illumination.

### BRIEF DESCRIPTION OF THE DRAWINGS

A better understanding of the exemplary embodiments will be had when reference is made to the accompanying drawings, wherein identical parts are identified with identical reference numerals, and wherein:

FIG. 1 is a schematic circuit diagram of an exemplary embodiment.

FIG. 2 is a planar side view of an exemplary embodiment used within a liquid crystal display assembly.

### DETAILED DESCRIPTION OF A PREFERRED EMBODIMENT

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

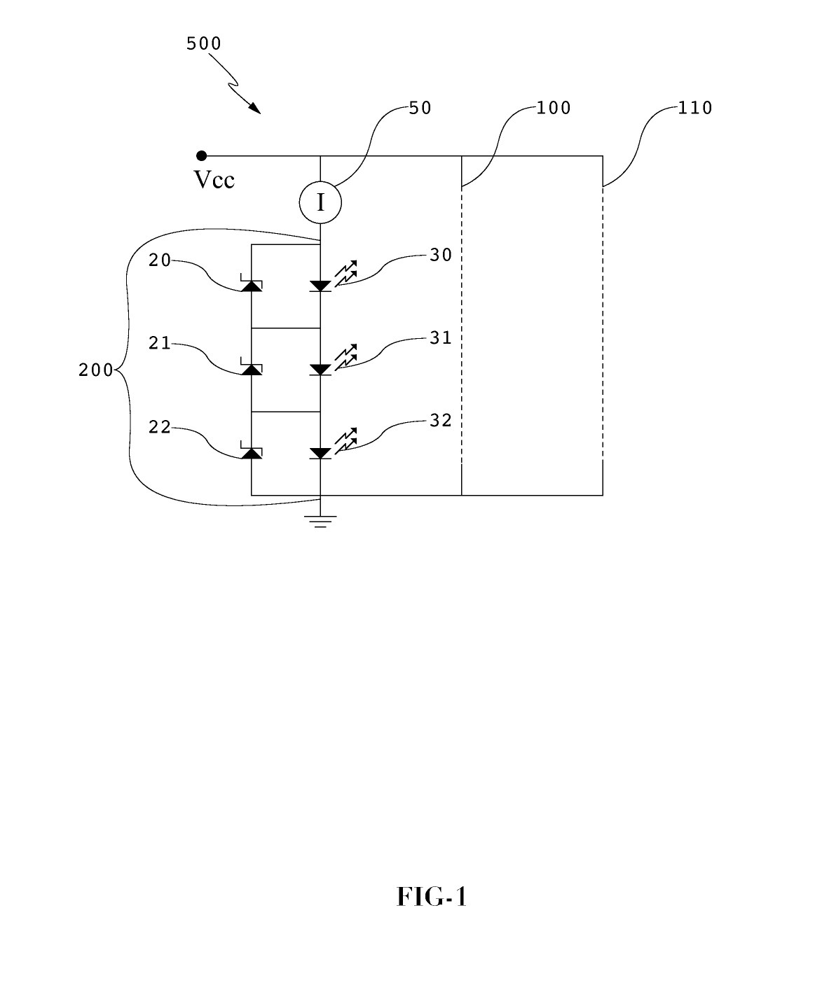

FIG. 1 shows an electrical schematic for an exemplary embodiment 500. A first LED and Zener diode string 200 is shown having LEDs 30, 31, and 32 connected in series. A Zener diode 20 is shown connected in parallel with LED 30 while Zener diode 21 is connected in parallel to LED 31 and Zener diode 22 is connected in parallel to LED 32. A current source 50 may be connected to the LED string 200 in order to drive the LEDs.

Additional LED and Zener diode strings 100 and 110 (indicated by the dashed lines) may be connected in parallel to the first LED and Zener diode string 200. Each additional LED and Zener diode string 100 and 110 may also be driven by a current source. There may be as many additional LED and Zener diode strings connected in parallel as desired for the circuit. Obviously, each LED and Zener diode string may contain more than three LED/Zener diode pairs.

As is well known in the art, the circuitry may contain additional elements than those shown in FIG. 1. Amplifiers, limiters, microprocessors, resistors, capacitors, and measurement devices may be included in some embodiments to further improve the performance of the circuit.

The LEDs and accompanying electrical connections may be a portion of a printed circuit board (PCB). The PCB may comprise a standard FR4 circuit board. An exemplary embodiment may utilize a low level of thermal resistance between the LEDs and the rear surface of the PCB. This allows heat to dissipate from the LEDs to the rear of the PCB where it may be removed from the lighting assembly by convection or conduction or both. An exemplary embodiment may use a metal core (sometimes aluminum) PCB for this purpose. The PCB for an exemplary embodiment may contain a metallic rear PCB surface where cooler air may pass over the surface and remove heat from the lighting assembly. In exemplary embodiments, this rear metallic surface (or thin plate) may be aluminum and may be in thermal communication with the LEDs. In some embodiments the rear surface (or thin plate) may also contain heat sinks or fins to facilitate the removal of heat from the PCB and LEDs. The surface of the PCB which contains the lights may be coated with a highly reflective coating and may also be of a specific color, depending on the specific requirements for the lighting application.

Embodiments can be utilized for any variety of illumination applications including but not limited to: architectural lighting, backlighting for static displays, backlighting for liquid crystal displays (LCDs), flashlights and other lamps, and home/office interior lighting. Embodiments may use any type of light-emitting diode. As known in the art, a light diffusing element may be placed in front of the LED assembly in order to diffuse the point-sources of light created by the LEDs.

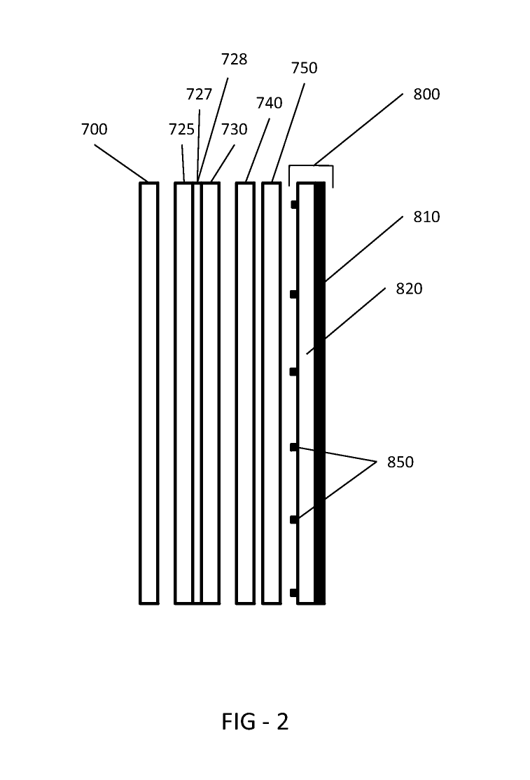

FIG. 2 is a planar side view of an exemplary embodiment used within a liquid crystal display assembly. In this embodiment, a pair of transparent substrates 725 and 730 may be used with liquid crystal material 727 sandwiched in between. Also between the transparent substrates 725 and 730 is an electrical controlling element 728 and is used to orient the liquid crystal material. The various types and designs for the electrical controlling elements 728 are well known in the art and will not be discussed further herein. A rear polarizer 740 may be placed behind the transparent substrates 725 and 730. A front polarizer 700 may be placed in front of the transparent substrates 725 and 730. A backlight assembly 800 may be placed behind the rear polarizer 740. A light diffusing element 750 may be placed between the backlight assembly 800 and the rear polarizer 740.

An exemplary backlight assembly 800 would contain a printed circuit board (PCB) 820 with a plurality of LEDs 850 mounted to the front surface of the PCB 820. The LEDs 850 are preferably electrically connected as shown and described in reference to FIG. 1 above, with zener diodes in parallel with each LED 850. The rear surface of the PCB 820 is preferably metallic and in thermal communication with the LEDs 850. In some embodiments, a thin metallic sheet 810 may be attached to the rear surface of the PCB 820. In an exemplary embodiment, the rear surface or thin metallic sheet 810 would be aluminum.

Having shown and described preferred embodiments, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. An LED circuit comprising:
a first plurality of LEDs electrically connected in series; and
a zener diode electrically connected in parallel to each of the first plurality of LEDs.

2. The LED circuit of claim 1 further comprising:
a first current source in electrical communication with the LEDs and zener diodes.

3. The LED circuit of claim 2 further comprising:
a second plurality of LEDs electrically connected in series to each other;
a zener diode connected in parallel to each of the second plurality of LEDs; and
a second current source in electrical communication with the second plurality of LEDs and zener diodes;
wherein the second plurality of LEDs and second current source are connected in parallel to the first plurality of LEDs and first current source.

4. A lighting assembly comprising:
a printed circuit board (PCB) having oppositely facing front and rear surfaces;
a first plurality of LEDs mounted to the front surface of the PCB and electrically connected with each other in series;
a second plurality of LEDs electrically connected in parallel to the first plurality of LEDs and mounted to the front surface of the PCB and electrically connected with each other in series; and
a zener diode electrically connected in parallel to each LED and mounted on the front surface of the PCB.

5. The lighting assembly of claim 4 wherein:
the PCB is a metal core PCB.

6. The lighting assembly of claim 4 further comprising:
a first current source in electrical communication with the first plurality of LEDs and the associated zener diodes; and
a second current source in electrical communication with the second plurality of LEDs and the associated zener diodes.

7. The lighting assembly of claim 6 further comprising:
a light diffusing element placed in front of the PCB.

8. The lighting assembly of claim 4 wherein:
the rear surface of the PCB is metallic.

9. The lighting assembly of claim 4 further comprising:
an aluminum plate in thermal communication with the rear surface of the PCB.

10. The lighting assembly of claim 9 further comprising:
a heat sink in thermal communication with the aluminum plate.

11. A liquid crystal display comprising:
a pair of transparent substrates with liquid crystal material sandwiched in between;
an electric controlling element placed between the transparent substrates;
a rear polarizer placed behind the transparent substrates;
a front polarizer placed in front of the transparent substrates;
a backlight placed behind the rear polarizer and having:
a printed circuit board (PCB) having oppositely facing front and rear surfaces,
a first plurality of LEDs mounted to the front surface of the PCB and electrically connected with each other in series,
a second plurality of LEDs electrically connected in parallel to the first plurality of LEDs and mounted to the front surface of the PCB and electrically connected with each other in series,
a zener diode electrically connected in parallel to each LED and mounted on the front surface of the PCB,
a first current source in electrical communication with the first plurality of LEDs and the associated zener diodes, and
a second current source in electrical communication with the second plurality of LEDs and the associated zener diodes; and
a light diffusing element placed between the rear polarizer and the backlight.

12. The liquid crystal display of claim 11 wherein:
the PCB is a metal core PCB.

13. The liquid crystal display of claim 11 wherein:
the rear surface of the PCB is metallic.

14. The liquid crystal display of claim 11 further comprising:
an aluminum plate in thermal communication with the rear surface of the PCB.

15. The liquid crystal display of claim 14 further comprising:
a heat sink in thermal communication with the aluminum plate.
